(19) United States
(12) Patent Application Publication
(10) Pub. No.: US 2026/0332010 A1
(43) Pub. Date: Oct. 22, 2026

(54) POWER GENERATOR POSITION CORRECTION DEVICE, POWER GENERATOR POSITION CORRECTION SYSTEM, POWER GENERATOR POSITION CORRECTION METHOD, AND POWER GENERATOR INSPECTION METHOD

(71) Applicant: Mitsubishi Generator Co., Ltd., Kobe City, Hyogo (JP)

(72) Inventors: Koji YONEKURA, Chiyoda-ku, Tokyo (JP); Ikuto OBATA, Chiyoda-ku, Tokyo (JP)

(73) Assignee: Mitsubishi Generator Co., Ltd., Kobe City, Hyogo (JP)

(21) Appl. No.: 19/157,958

(22) PCT Filed: Apr. 3, 2023
(86) PCT No.: PCT/JP2023/013783

§ 371 Date: Aug. 19, 2025

(51) Int. Cl. H02K 15/90; G01B 11/27

(52) U.S. Cl. CPC H02K 15/90; G01B 11/272

(57) ABSTRACT

A power generator position correction device provided for a generator raised and lowered in a vertical direction by a lifting device between a first position and a second position that are different in the vertical direction, comprising: a detection device detecting a horizontal position deviation, in a first plane perpendicular to the vertical direction, between the generator when located at the first position and the generator when located at the second position; and an adjustment device disposed below the generator in the vertical direction, arranged independently from a ceiling and a side wall of a building housing the generator, configured to move the generator only in a direction of a first axis and a direction of a second axis that are perpendicular to each other in the first plane, and adjusts the horizontal position deviation.

### TECHNICAL FIELD

The present disclosure relates to a power generator position correction device, a power generator position correction system, a power generator position correction method, and a power generator inspection method.

### BACKGROUND ART

As one form of a combined cycle power plant in which a generator is driven by both a gas turbine and a steam turbine, there exists a configuration in which a rotation shaft of a gas turbine is connected to one end of the rotation shaft of the generator, and a rotation shaft of a steam turbine is connected to the other end.

In this form of combined cycle power plant, the rotating shafts of the gas turbine, generator, and steam turbine are aligned on the same straight line. When inspecting the rotating shaft and rotor of the generator in such a combined cycle power plant, the rotating shaft of the generator is removed from the casing of the generator and the inspection is performed in the following inspection method.

First, the rotating shaft of the generator is separated from the rotating shafts of the gas turbine and steam turbine. Next, one of the gas turbine and steam turbine that are present in the axial direction of the generator is disassembled. Next, the generator is moved upward, and the rotating shaft of the generator is pulled out from the casing of the generator in the axial direction toward the space vacated by the disassembly. After that, the rotating shaft is placed in a set location and the shaft, rotor, etc. are inspected. In the above inspection method, the generator must be moved upwards once when the rotating shaft is pulled out.

There are various methods for moving the generator upwards, but a typical method is to place a hydraulic jack or the like between the generator and the foundation on which it is placed, and jack up the generator. In this method, the attitude and position of the generator change significantly, so a supervisor is stationed to check for interference between the generator and peripheral equipment, and for any misalignment. If the position of the jacked-up generator deviates from the set position, the supervisor connects the generator to the beams of the building with a chain block or the like, and adjusts the position of the generator while pulling the chain block. However, this method uses the beams of the existing building, so it is not possible to pull in any direction, and it is necessary to move the generator repeatedly to position it in the desired position, which takes time to adjust the position and makes the process complicated. Therefore, the following moving device has been disclosed, which does not require connection to the beams of the vertical roof, and allows for easy position adjustment.

That is, the conventional moving device abuts the tips of bolts (21, 22) against the side wall surface of the base that supports the rotating electric machine, and moves the base horizontally by rotating the bolts (21, 22), thereby adjusting the position of the rotating electric machine (see, for example, Patent Document 1).

### CITATION LIST

### Patent Document

Patent Document 1: Japanese Laid-Open Patent Publication No. 8-191558 (paragraphs [0014] to [0015])

### SUMMARY OF THE INVENTION

### Problem to be Solved by the Invention

However, with such a moving device, for example, when attempting to move the generator in the axial direction of the bolt (21) by rotating the bolt (21), the platform may shift in a direction other than the pushing direction of the bolt (21). When this occurs, adjustments using the bolt must be repeated many times until the generator is positioned at the desired position, posing a problem that position adjustment takes time and increases costs.

The present disclosure has been made to solve the above problem, and an object of the present disclosure is to provide a power generator position correction device, a power generator position correction system, a power generator position correction method, and a power generator inspection method that can shorten the work time for adjusting the position of the generator and reduce costs.

### Means to Solve the Problem

A power generator position correction device according to the present disclosure for a generator raised and lowered in a vertical direction by a lifting device between a first position and a second position that are different in the vertical direction includes: a detection device detecting a horizontal position deviation in a first plane perpendicular to the vertical direction, between the generator when located at the first position and the generator when located at the second position; and an adjustment device disposed below the generator in the vertical direction, arranged independently from a ceiling and a side wall of a building housing the generator, configured to move the generator only in a direction of a first axis and a direction of a second axis that are perpendicular to each other in the first plane, and adjusts the horizontal position deviation.

A power generator position correction system according to the present disclosure includes: the power generator position correction device configured as above; and a control unit deriving the horizontal position deviation, wherein, when the derived horizontal position deviation exceeds a set threshold value, the control unit transmits the horizontal position deviation to the adjustment device via a network, and adjusts a control amounts of the first pressing portion and the second pressing portion of the adjustment device based on the horizontal position deviation, to adjust the position of the generator so that the horizontal position deviation of the generator is reduced.

A power generator position correction method according to the present disclosure includes: a detection step of detecting the horizontal position deviation of the generator from the first position to the second position using the detection device; and a position adjustment step of adjusting the position of the generator, based on the detected horizontal position deviation, so that the horizontal position deviation is reduced by performing only once each of: a first movement step of moving the generator at the second position in the direction of the first axis, and a second movement step of moving the generator at the second position in the direction of the second axis.

A power generator inspection method according to the present disclosure in which rotating machines are connected to respective ends of a rotating shaft of the generator includes: a disconnection step of disconnecting the connections between the generator and the rotating machine connected to each end of the rotating shaft; a vertical stroke step of for raising and lowering the generator in the vertical direction between the first position and the second position that are different in the vertical direction; the detection step and the position adjustment step in the power generator position correction method; and an inspection process of inspecting the generator after the position adjustment step.

### Effect of the Invention

With the power generator position correction device, the power generator position correction system, the power generator position correction method, and the power generator inspection method to the present disclosure, it becomes possible to shortens the time required to adjust the position of the generator, leading to lower costs.

### BRIEF DESCRIPTION OF THE DRAWINGS

FIG. 1 is a side view showing a generator provided with a position correction device according to embodiment 1.

FIG. 2 is a top view showing a generator provided with a position correction device according to embodiment 1.

FIG. 3 is a perspective view showing a generator according to embodiment 1.

FIG. 4 is a perspective view showing a partially enlarged view of a generator provided with a position correction device according to embodiment 1.

FIG. 5 is a perspective view showing a partially enlarged view of a generator provided with a position correction device according to embodiment 1.

FIG. 6 is a perspective view showing the general configuration of a horizontal position adjuster according to embodiment 1.

FIG. 7 is a cross-sectional view showing the general configuration of a horizontal position adjuster according to embodiment 1.

FIG. 8 is a flow diagram showing a method of inspecting a generator and a method of correcting the position of a generator according to embodiment 1.

FIG. 9 is a side view showing a generator provided with a position correction device having a control unit according to embodiment 1.

FIG. 10 is a diagram showing the hardware configuration of a control unit according to embodiment 1.

### DESCRIPTION OF EMBODIMENTS

### Embodiment 1

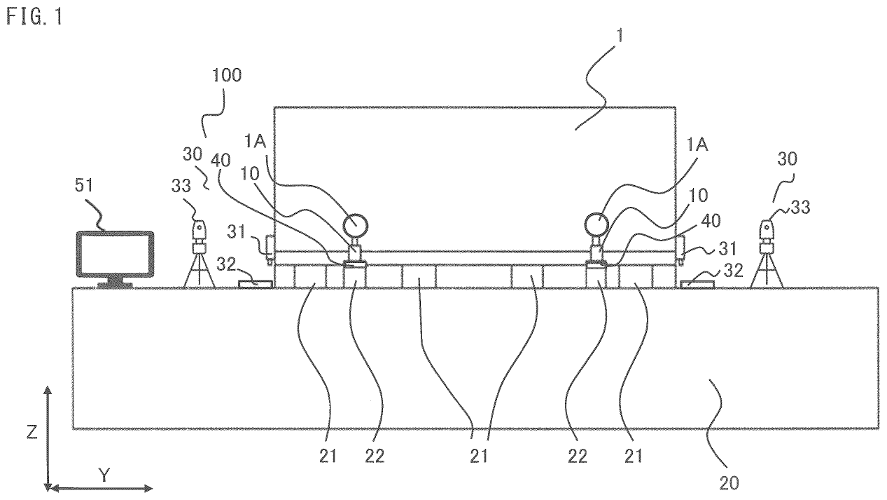

FIG. 1 is a side view showing a generator 1 provided with a position correction device 100 according to embodiment 1 and jacked up from a foundation 20 in the vertical direction Z.

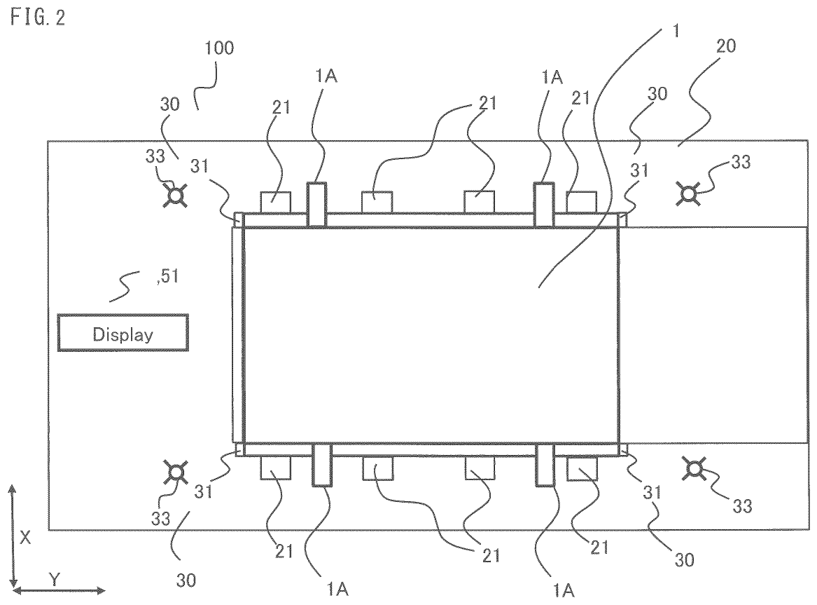

FIG. 2 is a top view showing the generator 1 provided with the position correction device 100 according to embodiment 1 and jacked up from the foundation 20 in the vertical direction Z.

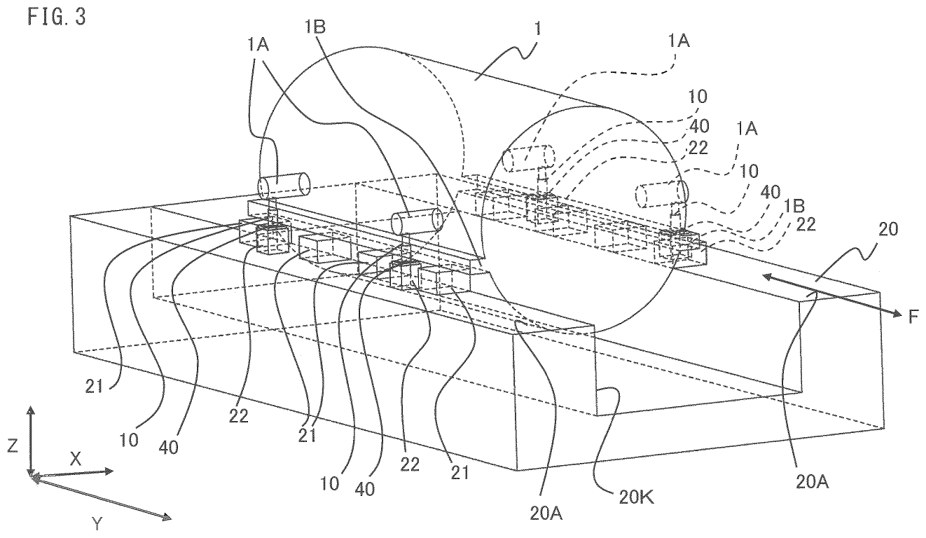

FIG. 3 is a perspective view showing the generator 1 provided with the position correction device 100 according to embodiment 1 and jacked up from the foundation 20 in the vertical direction Z. The position correction device 100 is not shown in FIG. 3.

First, the configuration of the generator 1 will be described with reference to FIG. 3.

The generator 1 includes a rotor and a rotation shaft (both not shown) therein. A rotation shaft of a gas turbine, which serves as a rotary machine, is connected to one end of the rotation shaft of generator 1, and a rotation shaft of a steam turbine, which also serves as a rotary machine, is connected to the other end of generator 1, thereby forming a single-shaft type combined cycle power plant.

During normal operation other than inspection, the generator 1 is placed directly on a foundation 20 in which a recess 20K is formed along the axial direction F. As mentioned above, the generator 1 shown in FIG. 3 is shown in a state in which it is jacked up from the foundation 20 in the vertical direction Z by a lifting device, which will be described later.

As shown in FIG. 3, the generator 1 has a cylindrical trunnion 1A as a protruding portion that protrudes radially outward with respect to the axial direction F on its outer circumferential surface, and a columnar support portion 1B that protrudes radially outward and extends along the axial direction F.

The trunnions 1A are provided in a total of four locations, two at each of the longer sides of a rectangular cross-section taken in a direction parallel to the axial direction F of the generator 1.

A support portion 1B is provided on the outer peripheral surface of the generator 1 so as to be positioned below the trunnions 1A in the vertical direction Z.

A hydraulic jack 10 as a lifting device is disposed below each trunnion 1A in the vertical direction Z. By abutting the upper end of the hydraulic jack 10 against the trunnion 1A and extending and retracting the hydraulic jack 10, it is possible to raise and lower the generator 1 along the vertical direction Z between the first position and the second position that are different in the vertical direction Z.

When the generator 1 is jacked up from the foundation 20 by the hydraulic jack 10, its support portion 1B are supported from below in the vertical direction Z by a plurality of supports 21.

Although not shown, during normal operation when the generator 1 is not jacked up, the support portion 1B is placed on the upper surface 20A of the foundation 20, and the part of the generator 1 located below the support portion 1B in the vertical direction Z is accommodated within a recess 20K of the foundation.

Next, we will explain the power generator position correction device 100, which is principal component of the present embodiment.

As shown in FIGS. 1 and 2, the power generator position correction device 100 includes a detection device 30 that detects a position deviation of the generator 1, a horizontal position adjuster 40 as an adjustment device that moves the generator 1 horizontally to correct the horizontal position deviation, and a display 51 as a display device.

First, the detection device 30 will be described.

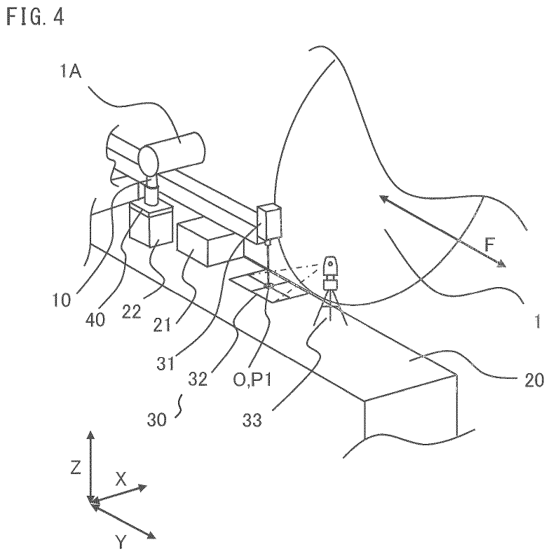

FIG. 4 is a perspective view of the detection device 30 detecting the position of the generator 1 in the first position before it is jacked up.

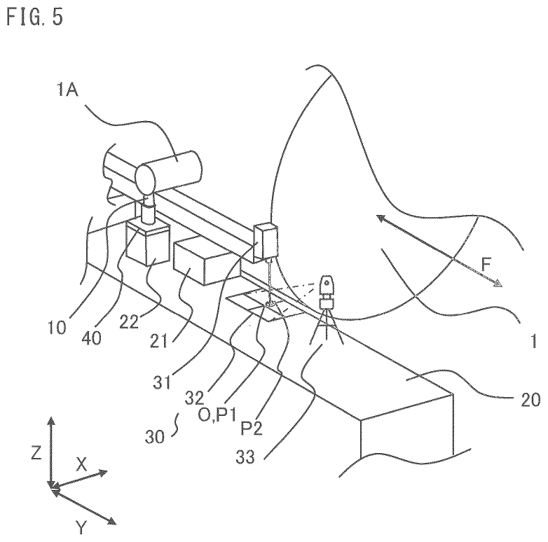

FIG. 5 is a perspective view of the detection device 30 detecting the position of the generator 1 in the second position after it is jacked up.

As shown in FIG. 4, the detection device 30 includes an irradiation device 31 that emits laser beam, a target 32 as a light receiving surface portion that receives the laser beam, and a camera 33 as an image display device that captures the target 32.

The irradiation device 31 is attached to the end of the axial direction F of the support part 1B of the generator 1, and constantly emits laser beam downward in the vertical direction Z toward the foundation 20.

The target 32 is provided on the foundation 20 below the vertical direction Z of the irradiation device 31, and receives the laser beam emitted from the irradiation device 31.

It should be noted that when a virtual plane including a horizontal direction perpendicular to the vertical direction Z, i.e., the optical axis direction of the laser beam, is defined as a first plane M (not shown), the target 32 is configured to be parallel to the first plane M.

The camera 33 captures the irradiation position of the laser beam on the target 32 and transmits the captured image to the display 51.

In this embodiment, irradiation devices 31 are provided at both ends of the two support portions 1B in the axial direction F. The target 32 and the camera 33 are provided for each irradiation device 31. In this way, detection devices 30 are provided at positions corresponding to the four corners of a rectangular cross-section parallel to the axial direction F of the generator 1.

The display 51 displays images from the cameras 33 provided at the four corners of the generator 1.

Next, the horizontal position adjuster 40 that moves the generator 1 will be described.

As shown in FIG. 1, each hydraulic jack 10 is placed on the respective horizontal position adjuster 40. The horizontal position adjusters 40 are mounted on receiving bases 22 installed on the foundation 20.

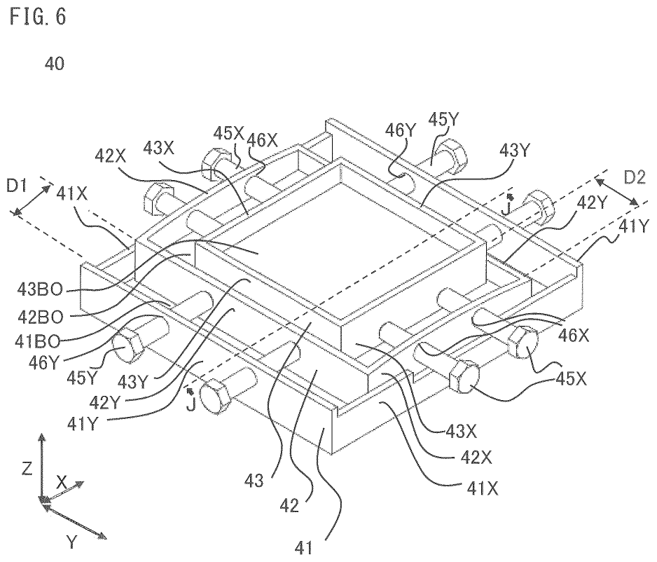

FIG. 6 is a perspective view showing a schematic configuration of the horizontal position adjuster 40 according to the first embodiment.

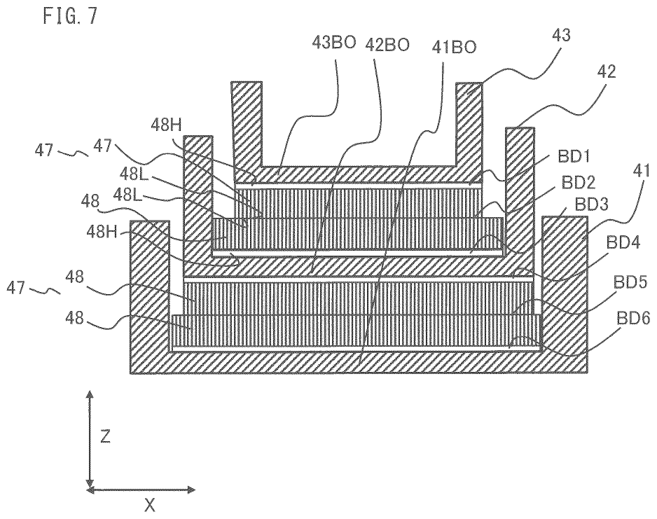

FIG. 7 is a cross-sectional view of the horizontal position adjuster 40 according to Embodiment 1, taken along line J-J in FIG. 6.

In the following description, two axes that are perpendicular to each other within the aforementioned first plane M are referred to as a first axial direction X and a second axial direction Y, respectively.

In the present embodiment, the axial direction F of the above-described generator 1 corresponds to the same direction as the second axial direction Y.

As shown in FIG. 6, the horizontal position adjuster 40 is configured by stacking three pedestals in the vertical direction Z, from bottom to top in the vertical direction Z, namely, a fixed pedestal 41 as a first pedestal, a movable pedestal 42 as a second pedestal, and a movable pedestal 43 as a third pedestal.

The fixed pedestal 41 has a rectangular bottom wall 41BO parallel to the first plane M, two first-axis side walls 41X that extend along the first axis direction X on the first plane M and face each other, and two second-axis side walls 41Y that extend along the second axis direction Y and face each other, forming a box shape. This fixed pedestal 41 is fixed to the receiving base 22 so as not to move on the receiving base 22.

The movable pedestal 42 has the rectangular bottom wall 42BO parallel to the first plane M, two first-axis side walls 42X that extend along the first axis direction X on the first plane M and face each other, and two second-axis side walls 42Y that extend along the second axis direction Y and face each other, forming a box shape. This movable pedestal 42 is not fixed to the movable pedestal 41.

The movable pedestal 43 has a rectangular bottom wall 43BO parallel to the first plane M, two first-axis side walls 43X that extend along the first axis direction X within the first plane M and face each other, and two second-axis side walls 43Y that extend along the second axis direction Y and face each other, forming a box shape. This movable pedestal 43 is not fixed to the movable pedestal 42.

The movable pedestal 42 is configured such that the outer surfaces of its first-axis side walls 42X are in sliding contact with the inner surfaces of the first-axis side walls 41X of the fixed pedestal 41, and the outer surfaces of its second-axis side walls 42Y have a set first distance D1 from the inner surfaces of the second-axis side walls 41Y of the fixed pedestal 41.

The movable pedestal 43 is configured such that the outer surfaces of its second-axis side walls 43Y are in sliding contact with the inner surfaces of the second-axis side walls 42Y of the movable pedestal 42, and the outer surfaces of its first-axis side walls 43X have a second distance D2 set from the inner surfaces of the first-axis side walls 42X of the movable pedestal 42.

The lower end of the hydraulic jack 10 is placed on the bottom wall 43BO of the movable pedestal 43.

The horizontal position adjuster 40 further includes a first pressing portion which presses the first-axis side walls 43X of the movable pedestal 43 along the second axial direction Y. In this embodiment, the first pressing portion is configured to include the jack bolt 45X as a first bolt that presses the first-axis side wall 43X of the movable pedestal 43, and first screw holes 46X provided in the first-axis side walls 42X of the movable pedestal 42, into which the jack bolts 45X are screwed.

The horizontal position adjuster 40 also includes a second pressing portion that presses the second-axis side wall 42Y of the movable pedestal 42 along the first axial direction X. In this embodiment, the second pressing portion is configured to include a jack bolt 45Y as a second bolt that presses the second-axis side wall 42Y of the movable pedestal 42, and a second screw hole 46Y provided in the second-axis side wall 41Y of the fixed pedestal 41, into which the jack bolt 45Y is screwed.

As shown in FIG. 7, low-friction sheets 47 are disposed between the fixed pedestal 41 and the movable pedestal 42, and between the movable pedestal 42 and the movable pedestal 43, as friction adjustment members for reducing the frictional force generated between the fixed pedestal 41 and the movable pedestal 42, and between the movable pedestal 42 and the movable pedestal 43.

The configuration of the low-friction sheet 47 will now be described.

As shown in FIG. 7, the low-friction sheet 47 is composed of two friction sheets 48.

Each friction sheet 48 has a high-friction surface 48H on one side, which suppresses relative movement with a member in contact therewith by means of frictional force, and a sliding surface 48L on the other side, which has a lower frictional force than the high-friction surface 48H and reduces the frictional force generated between itself and the contacting member.

The low-friction sheet 47 is formed by stacking the two friction sheets 48 such that their respective sliding surfaces 48L face each other.

As a result, when the hydraulic jack 10 supporting the generator 1 is placed on the bottom wall 43BO of the movable pedestal 43, the movable pedestal 43 and the friction sheet 48 disposed below the bottom wall 43BO of the movable pedestal 43 do not slip or move relative to each other at the boundary BD1 due to frictional force caused by the weight of the generator 1. Also, the movable pedestal 42 and the friction sheet 48 disposed above the bottom wall 42BO of the movable pedestal 42 do not slip or move relative to each other at the boundary BD3 due to frictional force caused by the weight of the generator 1.

Similarly, the movable pedestal 42 and the friction sheet 48 disposed below the bottom wall 42BO of the movable pedestal 42 do not slip at the boundary BD4. Also, the fixed pedestal 41 and the friction sheet 48 disposed above the bottom wall 41BO of the fixed pedestal 41 do not slip at the boundary BD6.

In contrast, at the boundaries BD2 and BD5 where the sliding surfaces 48L of the friction sheets 48 are in contact with each other, the overlapping friction sheets 48 slide and move relative to each other.

Here, in order to move the generator 1 in the first-axis direction X, the jack bolt 45Y is rotated to advance the jack bolt 45Y in the first-axis direction X.

As a result, the tip end portion of the jack bolt 45Y presses the second-axis side wall 42Y of the movable pedestal 42 in the first-axis direction X.

At this time, since the fixed pedestal 41 is fixed to the foundation 20, the friction sheets 48 that are in contact with each other at the boundary portion BD5 move relative to each other.

That is, the movable pedestal 42 and the movable pedestal 43 located above the boundary portion BD5 integrally slide in the first-axis direction X, and the generator 1 moves in the first-axis direction X via the hydraulic jack 10 placed on the movable pedestal 43.

At this time, since the first-axis side walls 42X of the movable pedestal 42 are in sliding contact with the first-axis side walls 41X of the fixed pedestal 41, the movable pedestal 42 does not move in the second-axis direction Y.

In this manner, the first-axis side walls 41X of the fixed pedestal 41 functions as a guide to prevent the movable pedestal 42 from moving in a direction other than the pushing direction of the jack bolt 45Y.

Note that although the jack bolt 45Y receives a reaction force from the movable pedestal 42, the jack bolt 45Y has a structure capable of withstanding the reaction force from the movable pedestal 42 by means of an internal thread provided in a second threaded hole 46Y of the fixed pedestal 41.

In addition, in order to move the generator 1 in the second-axis direction Y, the jack bolt 45X is rotated to advance the jack bolt 45X in the second-axis direction Y.

As a result, a tip end portion of the jack bolt 45X presses the first-axis side walls 43X of the movable pedestal 43 in the second-axis direction Y.

At this time, the friction sheets 48 that are in contact with each other at the boundary portion BD2 move relative to each other, and the movable pedestal 43 located above the boundary portion BD2 slides in the second-axis direction Y. That is, the generator 1 moves in the second-axis direction Y via the hydraulic jack 10 placed on the movable pedestal 43.

In this manner, a second-axis side walls 42Y of the movable pedestal 42 functions as a guide to prevent the movable pedestal 43 from moving in a direction other than the pushing direction of the jack bolt 45X.

Further, although the jack bolt 45X receives a reaction force from the movable pedestal 43, the jack bolt 45X has a structure capable of withstanding the reaction force from the movable pedestal 43 by means of an internal thread provided in a first threaded hole 46X of the movable pedestal 42.

In this manner, the horizontal position adjuster 40 is configured such that the movement direction of the generator 1 is restricted, so that the generator 1 does not move in a direction other than the pushing direction of the jack bolt.

As a result, it is possible to prevent the generator 1 from moving in an unintended direction.

The above shows one example of the configuration of the horizontal position adjuster 40, but a different configuration may be used so long as it is configured to be movable only in the first axial direction X and the second axial direction Y.

Furthermore, a jack bolt is shown as the tool for pressing the movable pedestals 42, 43, but this is not limited to this configuration as long as it is possible to move the movable pedestals 42, 43 in the first axial direction X and the second axial direction Y.

The vertical thickness of the friction sheet 48 is determined in accordance with the weight of the generator 1, and so even when a heavy generator 1 is placed on it, the friction sheets 48 can be moved smoothly relative to each other.

The following describes an inspection method for inspecting the generator 1 and a method for correcting the position of the generator 1 using the power generator position correction device 100 configured as described above.

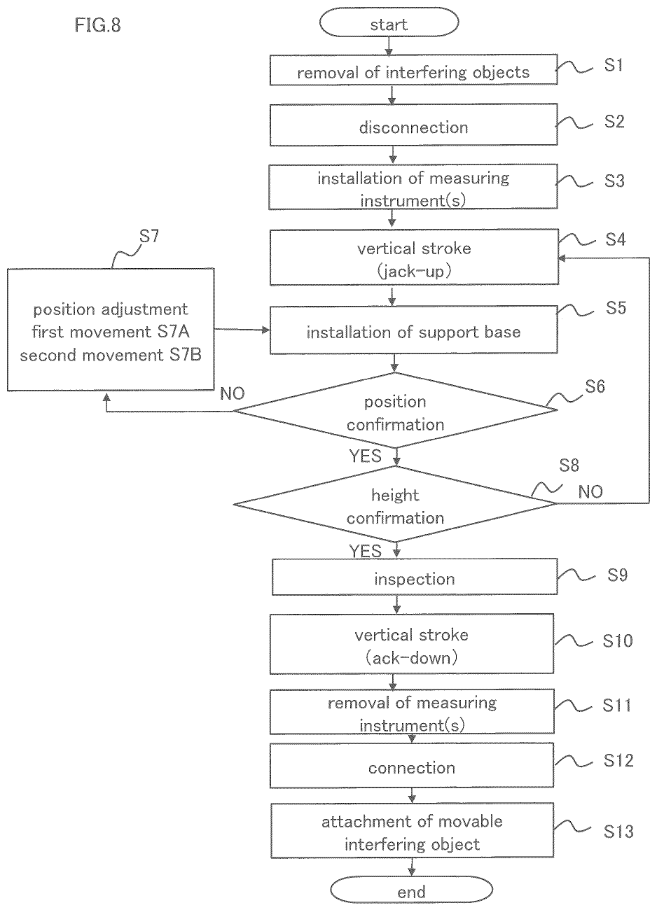

FIG. 8 is a flowchart showing an inspection method of the generator 1 and a position correction method of the generator 1 during inspection, according to the present embodiment.

As described above, during normal operation other than inspection, although not illustrated, the generator 1 is in a state in which a support portion 1B thereof is placed on an upper surface 20A of a foundation 20.

Here, the position of the generator 1 before being raised or lowered along a vertical direction Z, that is, in the following description, before the generator 1 is jacked up, is defined as a first position.

First, when the generator 1 is jacked up upward from the first position, an operator removes interference objects that obstruct the jack-up operation (interference object removal step S1).

As interference objects during the movement, although not illustrated, there are connection portions between a main terminal portion of the generator 1 and external terminals, various members existing around the connection portions, connection portions between respective rotation shafts of the gas turbine and the steam turbine, which are rotating machines, and the generator 1, and various members existing around the connection portions.

Next, the operator disconnects a connection between the rotation shaft of the gas turbine and the rotation shaft of the generator 1, and also disconnects a connection between the rotation shaft of the generator 1 and the rotation shaft of the steam turbine (disconnection step S2).

In the disconnection step S2, for example, connection bolts in a coupling portion that connects the rotation shafts to each other are removed.

Next, the operator installs a detection device 30, that is, the irradiation device 31, the target 32, and the camera 33, and confirms an irradiation position of a laser beam (instrument installation step S3).

In the instrument installation step S3, the operator installs the irradiation device 31 at four corners of the generator 1 in positions where interference with other equipment does not occur during the jack-up operation described later.

Then, the target 32 is installed on the foundation 20 below the irradiation device 31.

At this time, the target 32 is installed so as to be perpendicular to a vertical direction Z, that is, to an optical axis direction of the laser beam.

In this manner, the irradiation device 31 constantly emits the laser beam vertically onto the target 32.

Then, the operator adjusts positions of the irradiation device 31 and the target 32 such that an irradiation position of the laser beam emitted from the irradiation device 31 becomes a center position O of the target 32 (FIG. 4).

Then, the operator installs the camera 33 such that the entire target 32 is captured.

Images sent from the respective cameras 33 are aggregated and displayed on a single display 51.

Note that a plurality of displays may be provided and may be collectively arranged in one location.

Then, at least one operator monitors a horizontal position of the generator 1 on the display 51 during a jack-up operation of the generator 1 performed later.

Note that an irradiation position of the laser beam on the target 32 when the generator 1 is located at the first position before being jacked up is defined as a reference point P1.

Next, the operator installs a receiver 22 on the foundation 20 below each trunnion 1A of the generator 1, and installs a hydraulic jack 10 on the receiver 22 via a horizontal position adjuster 40.

Then, the operator extends the hydraulic jack 10 to jack up the generator 1 from the first position to the second position by several millimeters and float it from the foundation 20 (vertical stroke step S4).

Next, the operator installs a receiver 21 on the foundation below the support portion 1B of the generator 1, and places the generator 1 on the receiver 21 (receiver installation step S5).

Next, the operator, in the generator 1 jacked up to the second position as described above, confirms the irradiation position on the target 32 of laser light emitted from the irradiation device 31, as the movement point P2 (position confirmation step (detection step) S6).

The target 32 is installed on the foundation 20 independently from the generator 1.

Further, as described above, the target 32 is installed so as to be parallel to the first plane M, which is the virtual plane including the horizontal direction Y perpendicular to the vertical direction Z, that is, to the optical axis direction of the laser light.

Therefore, a displacement between a reference point P1 at the first position of the generator 1 on the target 32 as shown in FIG. 4, and a movement point P2 at the second position of the generator 1 on the target 32 as shown in FIG. 5, indicates an amount of horizontal position deviation of the generator 1 (FIG. 5).

In this manner, when the generator 1 is unintentionally moved in the horizontal direction while being vertically moved upward by the hydraulic jack 10, the operator can check the horizontal position deviation on a display 51.

As a result of the confirmation in the position confirmation step S6, if an abnormality, namely, a horizontal position deviation, is recognized, and if the horizontal position deviation exceeds a predetermined allowable value (detection step S6, No), the operator immediately performs a position adjustment to correct the horizontal position (adjustment step S7).

In the position adjustment step S7, the horizontal position adjuster 40 is used.

To move the generator 1 in the second-axis direction Y, the jack bolt 45X is rotated to move the second-axis side walls 43Y of the movable pedestal 43 in the second-axis direction Y (second movement step S7B).

Also, to move the generator 1 in the first-axis direction X, the jack bolt 45Y is rotated to move a second-axis side walls 42Y of the movable pedestal 42 in the first-axis direction X (first movement step S7A).

As described above, the horizontal position adjuster 40 includes a first-axis side walls 41X of a fixed pedestal 41 and a second-axis side walls 42Y of the movable pedestal 42, which function as guides to regulate the movement direction so that the generator 1 does not move in the direction other than the pushing direction of the jack bolts.

Accordingly, in the position adjustment step S7, by performing the first movement step S7A in the first-axis direction X only once, and the second movement step S7B in the second-axis direction Y only once, the generator 1 can be moved to a desired position.

Note that if movement of the generator 1 in the first-axis direction X or the second-axis direction Y is unnecessary, each movement amount is set to zero.

After the position adjustment step S7, the generator 1 is placed on the receiver 21 (receiver installation step S5), and the position confirmation step S6 is performed again.

If the horizontal position deviation of the generator 1 does not exceed the allowable value (position confirmation step S6, Yes), the operator confirms whether the generator 1 is jacked up to a predetermined height (height confirmation step S8).

Generally, the jack-up height required to extract a rotation shaft of the generator 1 is approximately several hundred millimeters to about 2000 mm. With a general hydraulic jack, the generator cannot be moved to the predetermined height in a single jack-up operation. Therefore, in the above-described receiver installation step S5, the receiver 21 is installed below the generator 1, and the generator 1 is once placed on the receiver 21.

In the height confirmation step S8, if the generator 1 has not yet reached the above-described predetermined height of several hundred millimeters to about 2000 mm, the process returns to the vertical stroke step S4, where the current second position is regarded as a new first position, and the generator 1 is further jacked up by several millimeters to a new second position.

Then, the steps from the receiver installation step S5 to the height confirmation step S8 are repeated, and jack-up is performed until the generator 1 reaches the desired height.

Note that, if the receiver 22 to which the horizontal position adjuster 40 is fixed is not attached to the foundation 20, when the vertical stroke step S4 is performed again, another receiver 22 may be inserted between the receiver 22 and the foundation 20, so that the horizontal position adjuster 40 is positioned further upward in the vertical direction Z.

In this manner, even when the extension length of the hydraulic jack 10 is limited, the generator 1 can be raised to the desired height.

Thus, in comparison with a structure in which a moving jig is fixed to the foundation, working time and cost can be reduced.

When the generator 1 reaches the desired height (height confirmation step S8, Yes), the operator extracts the rotation shaft of the generator 1 and inspects the rotation shaft, an internal rotor, and so on (inspection step S9).

After performing the inspection step S9, an vertical stroke step (jack-down) S10 is performed, and subsequent steps return the generator 1 to the state before the start of the operation in the reverse order of the above-described procedure (instrument removal step S11, connection step S12, interference object reattachment step S13). In this manner, the inspection work of the generator 1 is completed.

Note that the position confirmation step S6 and the position adjustment step S7 may also be performed after the vertical stroke step (jack-down) S10 following the inspection of the generator 1.

In this case, the position of the generator 1 before jack-down is set as the first position, and the position after jack-down is set as the second position. Then, the relationship between the laser irradiation position and the target 32 is checked on the display 51, and if the laser irradiation position is at the center of the target 32, the generator 1 is jacked down and placed on the receiver 21, and the horizontal position adjuster 40 is removed.

In the above description, an example is given in which the vertical stroke step S4 to jack up the generator 1 from the first position to the second position is performed, then the receiver installation step S5 to install the receiver 21 is performed, followed by the position confirmation step (detection step) S6 to detect the horizontal position deviation, and subsequently the position adjustment step S7 is performed.

However, the present disclosure is not limited to this example, and it is also possible to perform the position confirmation step (detection step) S6 in parallel with the vertical stroke step S4.

In this case, if the horizontal position deviation of the generator 1 exceeds the allowable value during the jack-up operation, the jack-up operation is temporarily stopped immediately, and the position adjustment step S7 is performed.

The power generator position correction device of the present embodiment configured as described above is a position correction device for a generator that is raised and lowered in the vertical direction by a lifting device between a first position and a second position that are different in the vertical direction.

The device comprises: a detection device detecting a horizontal position deviation in a first plane perpendicular to the vertical direction, between the generator when located at the first position and the generator when located at the second position; and an adjustment device disposed below the generator in the vertical direction, arranged independently from a ceiling and a side wall of a building housing the generator, configured to move the generator only in a direction of a first axis and a direction of a second axis that are perpendicular to each other in the first plane, and adjusts the horizontal position deviation.

In this manner, by moving the generator with the adjustment device that is configured to be movable only in the direction of the first axis and the direction of the second axis, which are orthogonal to each other in the first plane including the horizontal direction perpendicular to the vertical direction, movement of the generator in directions other than the first axis and the second axis is prevented, and the working time for position adjustment of the generator can be reduced, thereby achieving cost reduction.

Moreover, since the adjustment device is arranged independently from the ceiling and the side wall of the building housing the generator, it is not necessary to use large and special equipment such as rails or chains installed on the ceiling.
Accordingly, the number of workers required for position monitoring and position adjustment can be reduced, and further cost reduction can be achieved.

The power generator position correction method of the present embodiment configured as described above comprises: a detection step of detecting the horizontal position deviation of the generator from the first position to the second position using the detection device; and a position adjustment step of adjusting the position of the generator, based on the detected horizontal position deviation, so that the horizontal position deviation is reduced by performing only once each of: a first movement step of moving the generator at the second position in the direction of the first axis, and a second movement step of moving the generator at the second position in the direction of the second axis.

In this manner, by performing only once the first movement step of moving the generator in the direction of the first axis, and the second movement step of moving the generator in the direction of the second axis, the generator can be quickly moved to a desired position. Accordingly, the working time for position adjustment of the generator can be significantly reduced, and further cost reduction can be achieved.

Next, a power generator position correction device 100A having a configuration different from the above is described.

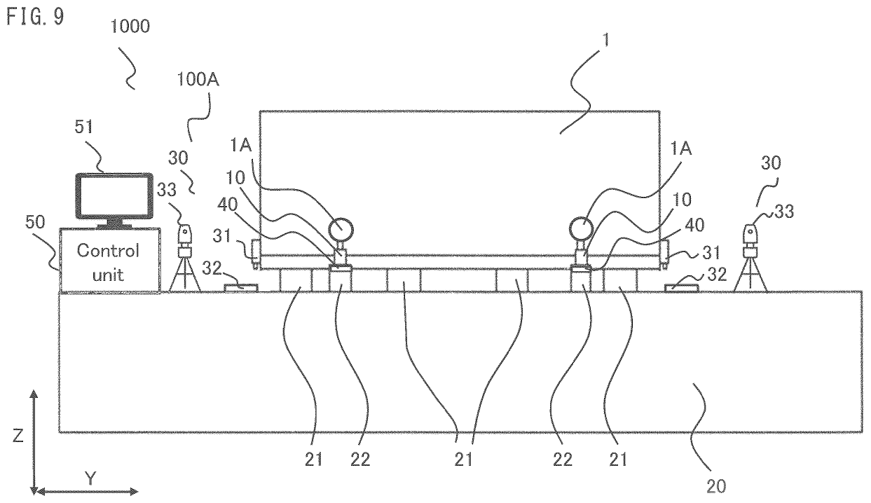

FIG. 9 is a side view showing a generator 1 provided with the power generator position correction device 100A according to Embodiment 1.

The position correction device 100A of the present embodiment is a configuration in which a control unit 50 is added to the aforementioned position correction device 100, and a power generator position correction system 1000 is constructed thereby.

In the above-mentioned position correction device 100, the horizontal position deviation of the generator 1 is visually confirmed by an operator using a display 51. In contrast, in the position correction device 100A, the control unit 50 automatically detects the horizontal position deviation.

The detection of the horizontal position deviation by the control unit 50 is performed, for example, by arranging a light sensor on the target 32, and transmitting the irradiation position of the laser beam detected by the light sensor to the control unit 50 via a network, so that the control unit 50 analyzes the irradiation position to detect the horizontal position deviation.
Alternatively, a position detection device such as an image analysis device may be provided independently of the generator 1, for example, on the ceiling of the building, and the control unit may acquire the position of the generator 1 from the image analysis device via a network and perform analysis.

More specifically, the control unit 50 defines, as a reference point, an irradiation position of the laser beam on the target 32 when the generator 1 is located at the first position, and defines, as a moved point, an irradiation position of the laser beam on the target 32 when the generator 1 is located at the second position, and detects a difference between the reference point and the moved point in the first plane as the horizontal position deviation.

Then, when the detected horizontal position deviation exceeds an allowable value that is a set threshold value, the control unit 50 transmits the horizontal position deviation to the horizontal position adjuster 40 via a network.

Then, in order to reduce the detected horizontal position deviation, the control unit 50 rotates jack bolts 45X and 45Y while adjusting rotation numbers as control amounts for the respective jack bolts by using a rotation device (not shown), thereby adjusting the position of the generator 1.

Accordingly, position adjustment of the generator can be performed based on the horizontal position deviation detected with higher accuracy than visual confirmation by an operator.

Thus, the workload of the operator can be reduced, and significant improvement in work efficiency can be achieved.

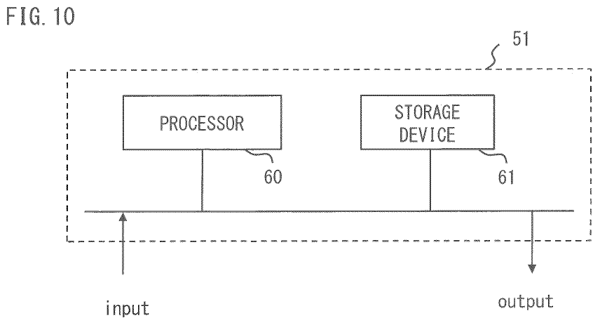

FIG. 10 is a diagram showing a hardware configuration of the control unit according to Embodiment 1.

A control device 51 serving as the control unit 50 is composed of a processor 60 and a storage 61, as illustrated in FIG. 10.

The storage 61 includes a volatile storage device such as a random access memory (not shown) and a non-volatile auxiliary storage device such as a flash memory. A hard disk may be used as the auxiliary storage device instead of the flash memory.

The processor 60 executes a program input from the storage 61.

In this case, the program is input to the processor 60 via the volatile storage device from the auxiliary storage device.

The processor 60 may output calculation results and other data to the volatile storage device of the storage 61, or may store the data in the auxiliary storage device via the volatile storage device.

Although exemplary embodiments are described in the present application, various features, aspects, and functions described in the embodiments are not limited to the application to specific embodiments, and can be applied alone or in various combinations.

Therefore, numerous modifications not illustrated can be envisioned within the scope of the technology disclosed in the present application.

For example, modifications, additions, or omissions of at least one component are included.

### DESCRIPTION OF THE REFERENCE CHARACTERS

1: generator 10: hydraulic jack (lifting device)
30: detection device
31: irradiation device
32: target (light receiving surface portion)
33: camera (imaging device)
40: horizontal position adjuster (adjustment device)
41: fixed pedestal (first pedestal)
42: movable pedestal (second pedestal)
43: movable pedestal (third pedestal)
41BO, 42BO, 43BO: bottom wall
41X, 42X, 43X: first-axis side wall
41Y, 42Y, 43Y: second-axis side wall
45X: jack bolt (first bolt)
45Y: jack bolt (second bolt)
46X: first threaded hole
46Y: second threaded hole
47: low-friction sheet (friction adjustment member)
100, 100A: power generator position correction device
1000: power generator position correction system

1. A power generator position correction device for a generator raised and lowered in a vertical direction by a lifting device between a first position and a second position that are different in the vertical direction,
comprising:
a detection device detecting a horizontal position deviation in a first plane perpendicular to the vertical direction, between the generator when located at the first position and the generator when located at the second position; and
an adjustment device disposed below the generator in the vertical direction, arranged independently from a ceiling and a side wall of a building housing the generator, configured to move the generator only in a direction of a first axis and a direction of a second axis that are perpendicular to each other in the first plane, and adjusts the horizontal position deviation.

2. The power generator position correction device according to claim 1, wherein
the adjustment device comprises three pedestals stacked in the vertical direction, each of pedestal has a rectangular bottom wall parallel to the first plane, two first-axis side walls extending in the direction of the first axis and facing each other, and two second-axis side walls extending in the direction of the second axis and facing each other to form a box shape,
wherein the pedestals are defined as a first pedestal, a second pedestal, and a third pedestal from bottom to top in the vertical direction,
the second pedestal configured such that outer surfaces of the first-axis side walls of the second pedestal are in sliding contact with inner surfaces of the first-axis side walls of the first pedestal, and the outer surfaces of the second-axis side walls of the second pedestal have a first gap from inner surfaces of the second-axis side walls of the first pedestal,
the third pedestal configured such that outer surfaces of the second-axis side walls of the third pedestal are in sliding contact with inner surfaces of the second-axis side walls of the second pedestal, and outer surfaces of the first-axis side walls of the third pedestal have a second gap from inner surfaces of the first-axis side walls of the first pedestal.

3. The power generator position correction device according to claim 2 comprising:
a first pressing portion pressing the first-axis side wall of the third pedestal in the direction of the second axis; and
a second pressing portion pressing the second-axis side wall of the second pedestal in the direction of the first axis.

4. The power generator position correction device according to claim 3, wherein
the first pressing portion configured to have
first bolts pressing the first-axis side wall of the third pedestal, and
first threaded holes provided on the first-axis side walls of the second pedestal, configured to receive the first bolts, wherein
the second pressing portion configured to have
second bolts pressing the second-axis side wall of the second pedestal, and
second threaded holes provided on the second-axis side walls of the first pedestal, configured to receive the second bolt.

5. The power generator position correction device according to claim 2, wherein
friction adjustment members are provided between the first pedestal and the second pedestal, and between the second pedestal and the third pedestal, to reduce frictional forces generated between the first pedestal and the second pedestal, and between the second pedestal and the third pedestal.

6. The power generator position correction device according to claim 5, wherein
a thickness in the vertical direction of the friction adjustment member is determined according to a weight of the generator.

7. The power generator position correction device according to claim 1, wherein
the detection device comprises:
an irradiation device provided on the generator emitting a laser beam downward in the vertical direction;
and
a light receiving surface portion, disposed independently form the generator below the irradiation device in the vertical direction, and parallel to the first plane receiving the laser beam.

8. The power generator position correction device according to claim 7,
wherein the detection device includes an imaging device captures an irradiation position of the laser beam on the light receiving surface portion, and displays the captured irradiation position on a display device.

9. A power generator position correction system comprising:
the power generator position correction device according to claim 3; and
a controlling circuitry deriving the horizontal position deviation, wherein,
when the derived horizontal position deviation exceeds a set threshold value,
the controlling circuitry transmits the horizontal position deviation to the adjustment device via a network, and adjusts a control amount of the first pressing portion and the second pressing portion of the adjustment device based on the horizontal position deviation, to adjust the position of the generator so that the horizontal position deviation of the generator is reduced.

10. The power generator position correction system according to claim 9, wherein
the detection device comprising:
an irradiation device provided on the generator emitting a laser beam downward in the vertical direction;
and
a light receiving surface portion, disposed independently form the generator below the irradiation device in the vertical direction, and parallel to the first plane receiving the laser beam, wherein
the controlling circuitry determines, as a reference point, an irradiation position on the light receiving surface portion of the laser beam emitted from the irradiation device when the generator is located at the first position,
and, as a moved point, an irradiation position on the light receiving surface portion of the laser beam emitted from the irradiation device when the generator is located at the second position, and detects the difference between the reference point and the moved point in the first plane as the horizontal position deviation.

11. A power generator position correction method using the power generator position correction device according to claim 1, comprising:
a detection step of detecting the horizontal position deviation of the generator from the first position to the second position using the detection device; and
a position adjustment step of adjusting the position of the generator, based on the detected horizontal position deviation, so that the horizontal position deviation is reduced by performing only once each of:
a first movement step of moving the generator at the second position in the direction of the first axis, and
a second movement step of moving the generator at the second position in the direction of the second axis.

12. A power generator inspection method, in which rotating machines are connected to respective ends of a rotating shaft of the generator, using the power generator position correction method of claim 11, comprising:
a disconnection step of disconnecting the connections between the generator and the rotating machine connected to each end of the rotating shaft;
a vertical stroke step of for raising and lowering the generator in the vertical direction between the first position and the second position that are different in the vertical direction;
the detection step and the position adjustment step in the power generator position correction method; and
an inspection step of inspecting the generator after the position adjustment step.

13. The power generator position correction device according to claim 3, wherein
friction adjustment members are provided between the first pedestal and the second pedestal, and between the second pedestal and the third pedestal, to reduce frictional forces generated between the first pedestal and the second pedestal, and between the second pedestal and the third pedestal.

14. The power generator position correction device according to claim 4, wherein
friction adjustment members are provided between the first pedestal and the second pedestal, and between the second pedestal and the third pedestal, to reduce frictional forces generated between the first pedestal and the second pedestal, and between the second pedestal and the third pedestal.

15. The power generator position correction device according to claim 2, wherein
the detection device comprises:
an irradiation device provided on the generator emitting a laser beam downward in the vertical direction;
and
a light receiving surface portion, disposed independently form the generator below the irradiation device in the vertical direction, and parallel to the first plane receiving the laser beam.

16. The power generator position correction device according to claim 3, wherein
the detection device comprises:
an irradiation device provided on the generator emitting a laser beam downward in the vertical direction;
and
a light receiving surface portion, disposed independently form the generator below the irradiation device in the vertical direction, and parallel to the first plane receiving the laser beam.

17. The power generator position correction device according to claim 4, wherein
the detection device comprises:
an irradiation device provided on the generator emitting a laser beam downward in the vertical direction;
and
a light receiving surface portion, disposed independently form the generator below the irradiation device in the vertical direction, and parallel to the first plane receiving the laser beam.

18. The power generator position correction device according to claim 5, wherein
the detection device comprises:
an irradiation device provided on the generator emitting a laser beam downward in the vertical direction;
and
a light receiving surface portion, disposed independently form the generator below the irradiation device in the vertical direction, and parallel to the first plane receiving the laser beam.

19. The power generator position correction device according to claim 6, wherein
the detection device comprises:
an irradiation device provided on the generator emitting a laser beam downward in the vertical direction;
and
a light receiving surface portion, disposed independently form the generator below the irradiation device in the vertical direction, and parallel to the first plane receiving the laser beam.

20. The power generator position correction device according to claim 14, wherein
the detection device comprises:
an irradiation device provided on the generator emitting a laser beam downward in the vertical direction;
and
a light receiving surface portion, disposed independently form the generator below the irradiation device in the vertical direction, and parallel to the first plane receiving the laser beam.
